(19) United States
(12) Patent Application Publication
(10) Pub. No.: US 2002/0165022 A1
(43) Pub. Date: Nov. 7, 2002

(54) Game module adding service system

(76) Inventor: Akira Hiraoka, Sagamihara-shi (JP)

Correspondence Address: SULLIVAN LAW GROUP, 5060 NORTH 40TH STREET, SUITE 120, PHOENIX, AZ, 85018, US

(21) Appl. No.: 10/107,018

(22) Filed: Mar. 25, 2002

(30) Foreign Application Priority Data
Mar. 27, 2001 (JP) JP2001-89895
Jul. 18, 2001 (JP) JP2001-217538

(51) Int. Cl. G06F 17/00

(52) U.S. Cl. 463/25

(57) ABSTRACT

A game module 12 is added to a home page 11. The game results are fixed with the prize winners on a real time basis. When a game is over, the customer knows immediately whether the customer has won a prize. If the customer has won a prize, the prize is given to the customer on the spot and the customer's name is added to the prize winners' list.

Repetitive challenges may increase advertising effect of the home page because the home page would be looked at repeatedly. If the facts of winning the prize are displayed on the applicants' terminals on a real time basis, the applicants would rely on the game. The customers who have won the upper prizes are apt to let their acquaintances know their winning, which would enhance the number of customers who look at the home page.

### DETAIL DESCRIPTION OF THE INVENTION

1. Field of the Invention

The present invention is related to a system adapted to be added to a web site for enhancing reference frequency of the web site by adding a game module to the web site for commodity advertisement to be looked at through a network.

2. Background of the Invention

Many web sites are registered on the servers in the internet for presentation of commodities to promote sales. However, since there are so many web sites, the probability for a customer to find a certain web site is small. Therefore, efforts are made for the URLs (or the internet addresses) of the web sites to be registered in as many search engines as possible. In addition, banner advertisements are registered in various web sites linking to their home pages.

[Problem(s) to be Solved by the Invention]

There have been problems to be solved in the prior art described above as follows:

Even if a certain number of customers open the home page as a result of the efforts described above, they may not carefully look at the commodity presentation there. Some of them may move to other web sites after reading only the title of the home page. The home page may be designed with ingenuity. However, it is not easy to have the customers spare time for reading the explanation of the commodity, if the customers are not interested in the commodity. It is especially important to let the customers know the new products during the new product campaign, and sometimes, presents are provided to some of those who have answered a questionnaire and chosen by drawing lot. However, most of the customers think that lot is rarely drawn for them, and the number of applicants to the lot may not be large enough as expected.

### SUMMARY OF THE INVENTION

The present invention is to solve the problems described above, and is configured as follows:

[Configuration 1]

A system adapted to be added to a web site, the system comprising: a game module adapted to be added to a web site for advertising a commodity, the web site being adapted to be looked at through a network, the game module executing at least one game; a prize winning process module for collecting information for giving pre-determined privilege to prize winners of the game executed by the game module; a prize winner display module for displaying a prize winners' list listing up prize winners who won the prize; and a prize winners' list revising module for adding new prize winners to the prize winners' list, the new prize winners being processed by the prize winning process module.

[Configuration 2]

The system adapted to be added to a web site according to Configuration 1, the system further comprising: a customer information registering module for registering customer information in a customer information database, the customer information being collected by the prize winning process module.

[Configuration 3]

The system adapted to be added to a web site according to Configuration 1, the system further comprising: a prize winner condition customizing module for arbitrarily setting conditions for prize winners of the game which is executed by the game module.

[Configuration 4]

A game module adding service system comprising: at each of a plurality of web sites: a game module adapted to be added at a web page for commodity advertisement to be looked at through a network, the game module executing at least one game; a prize winning process module for collecting information for giving pre-determined privilege to prize winners of the game executed by the game module; a prize winner display module for displaying a prize winners' list listing up prize winners who won the prize; a prize winners' list revising module for adding new prize winners to the prize winners' list, the new prize winners being processed by the prize winning process module; and an operation state informing module for sending information of operation state of the prize winning process module to a managing server; and at the managing server connected to the web sites via the network: information collecting means for collecting information received from the operation state informing modules of the plurality of web sites; and money charging means for charging fee for using the game module by analyzing the information collected by the information collecting means.

[Configuration 5]

A game module adding service system comprising: at a managing server: a game module for executing at least one game; a prize winning process module for collecting information for giving pre-determined privilege to prize winners of the game executed by the game module; a prize winner display module for displaying a prize winners' list listing up prize winners who won the prize; a prize winners' list revising module for adding new prize winners to the prize winners' list, the new prize winners being processed by the prize winning process module; information collecting means for collecting information of operation state of the prize winning process module; and money charging means for charging fee for using the game module by analyzing the information collected by the information collecting means; and at a web site connected to the managing server via a network: means for linking the game module to a commodity advertising web page adapted to be looked at via the network.

[Configuration 6]

A game module adding service system comprising game controlling means for controlling at least one game, the game controlling means including: a game module for executing the game; a prize winning process module for collecting information for giving pre-determined privilege to prize winners of the game executed by the game module; a prize winner display module for displaying a prize winners' list listing up prize winners who won the prize; a prize winners' list revising module for adding new prize winners to the prize winners' list, the new prize winners being processed by the prize winning process module; information collecting means for collecting information of operation state of the prize winning process module; and money charging means for charging fee for using the game module by analyzing the information collected by the information collecting means; wherein: the game module is disposed at a web site, and means for starting the game module is disposed on a commodity advertising web page adapted to be looked at via network; and the prize winning process module, the prize winner display module, the prize winners' list revising module, the information collecting means and the money charging means are disposed at a managing server, and are started by the game module.

[Configuration 7]

The game module adding service system according to Configuration 6, wherein: procedure before the prize winning process is started is performed at the web site; and the prize winning process is started in response to a request from the web site.

### BRIEF DESCRIPTION OF THE DRAWINGS

FIG. 1 is a block diagram showing an embodiment of a system adapted to be added to a web site according to the present invention, wherein FIG. 1(a) is a schematic diagram of a network, and FIG. 1(b) is a block diagram of the web page and program modules stored in a web server for commodity advertising;

FIG. 2(a) shows a specific example of a commodity advertising web page 11 and a game module 12, and FIG. 2(b) shows an example of an operation display image of a game prize winning condition customizing module 19;

FIG. 3(a) shows a web page displayed when a prize explanation button 27 of the game module 12 shown in FIG. 2(a) is clicked, and FIG. 3(b) shows a page displayed when a prize winners' list display button 28 is clicked;

FIG. 4(a) shows an example of a web page for presentation of a new commodity, and FIG. 4(b) shows a web page displayed for prize winning process after a customer has won a prize as a result of a game module operation;

FIG. 5 is an explanatory diagram of a web page which a prize winning process module 14 displays;

FIG. 6(a) is a explanatory diagram of a page for confirmation of inputted information, and FIG. 6(b) shows a page displaying guidance of prize sending procedure;

FIG. 7 is a flow chart showing sequential procedure of modules for displaying and executing web pages sequentially;

FIG. 8(a) is an operational flow chart in a case when the prize explanation button 27 is clicked, FIG. 8(b) is an operational flow chart of displaying the prize winners' list. FIG. 8(c) is an operational flow chart of deciding truth or false with the prize winning process module;

FIG. 9 is a block diagram showing a modified embodiment of a system adapted to be added to a web site according to the present invention;

FIG. 10 is a block diagram showing the managing server 4 which has all the game controlling modules 9 required for the game;

FIG. 11 is an operational flow chart of the system shown in FIG. 9;

FIG. 12 is a block diagram showing a managing server where the game module 12 and the game prize winning condition customizing module 19 are disposed in the commodity advertising web server and the other game control modules 9 are disposed in the managing server 4; and

FIG. 13 is an operational flow chart of the system shown in FIG. 12.

### PREFERRED EMBODIMENTS OF THE INVENTION

Now, specific embodiments of the present invention are described.

In this invention, a game module is added to a home page. A game module may be posted at any place on a home page. The game module is a computer program executed by operation of the customer who is looking at the home page. Any games may be executed through which prize winners are selected. For example, ten (10) first-prize winners may obtain the privilege of purchasing a new product with 50% discount, fifty (50) second-prize winners may obtain the privilege of purchasing new products with 30% discount, and five hundred (500) third-prize winners may obtain the privilege of purchasing new products with 10% discount. Thus, the customers look forward to the results of the games. In addition, the game results are fixed with the prize winners on a real time basis. When a game is over, the customer knows immediately whether the customer has won a prize. If the customer has won a prize, the prize is given to the customer on the spot and the customer's name is added to the prize winners' list.

A customer can challenge the game any times as far as a pre-determined number of prize winners have been decided. The chance of winning prizes may be optionally increased by repetitive challenges. Repetitive challenges may increase advertising effect of the home page because the home page would be looked at repeatedly. If the probability of winning the third prizes is high and the facts of winning the prize are displayed on the applicants' terminals on a real time basis, the applicants would rely on the game, even if the first or second prizes may be rarely won. The applicants would think that they have a chance to win the first or second prize if they try again. Therefore, some of the applicants may abandon their acquired right to get the third prizes and may further challenge the game to win the first or second prizes. The customers who have won the upper prizes are apt to let their acquaintances know their winning, which would enhance the number of customers who look at the home page.

If a new commodity is a prize of the game, the customers who are going to start the game would read the presentation of the new commodity on the home page in order to decide whether they want to get the commodity or not, before they start the game. Thus, the object of the home page provider is achieved. In addition, the customers' information is advantageously obtained when they go through the due formalities to get prizes. Now, the present invention is explained referring to specific examples.

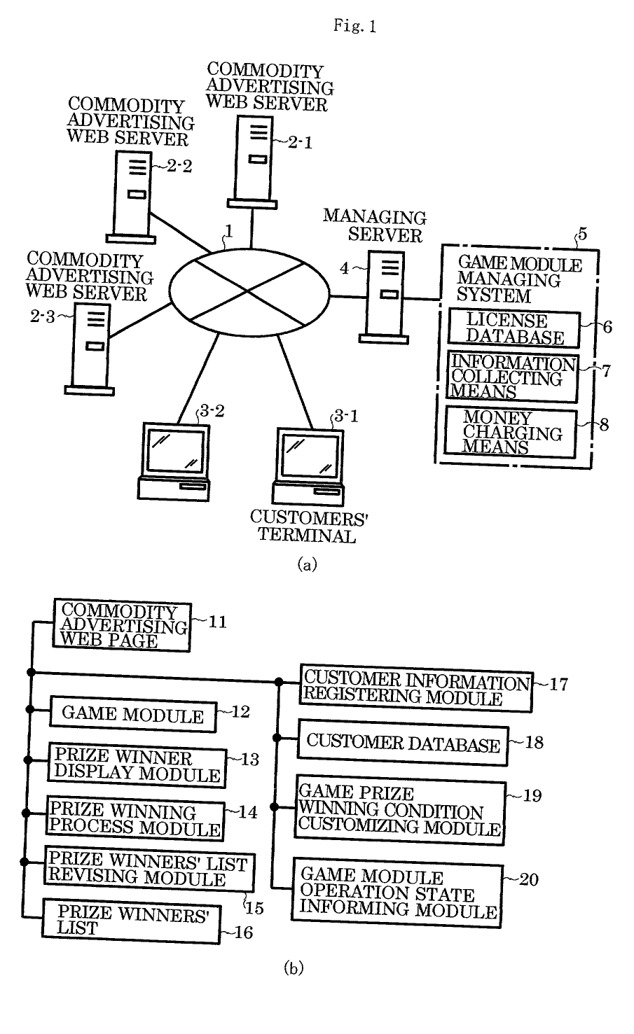

FIG. 1 is a block diagram showing an embodiment of a system adapted to be added to a web site according to the present invention. FIG. 1(a) is a schematic diagram of a network, and FIG. 1(b) is a block diagram of the web page and program modules stored in a web server for commodity advertising.

As shown in FIG. 1(a), commodity advertising web servers 2-1, 2-2 and 2-3 are connected to a network 1. These web servers have set their respective web sites and home pages for commodity advertising through the network 1. Customers' terminals 3-1 and 3-2 can be connected to the web sites and the home pages can be looked at on them. The customers' terminals may be personal computers, for example. It is to be understood that the present invention can also be applied to looking at home pages on other terminals such as mobile computers or mobile phones. In the present invention, a game module is added to the commodity advertising web pages of the commodity advertising web sites. The game module may be produced, provided and charged by a service provider, for example. A managing server 4 is connected to the network 1 in order to charge the usage fee of the game module. The managing server 4 has a game module managing system 5 which includes a license database 6, information collecting means 7 and money charging means 8. The information collecting means 7 and the money charging means 8 comprise computer programs.

As shown in FIG. 1(b), a commodity advertising web page 11 is stored in a memory device of the commodity advertising web server. This web page is looked at from the customers' terminals 3-1 and 3-2 through the network 1. In the memory device of the commodity advertising web server, computer programs such as a game module 12, a prize winner display module 13, a prize winning process module 14 and a prize winners' list revising module 15 are set up. A prize winners' list 16 is also stored in the memory device. The prize winners' list 16 is a data for displaying prize winners of the game. In addition, a customer information registering module 17, a customer database 18, a game prize winning condition customizing module 19 and a game module operation state informing module 20 are stored. Now, functions and specific examples of the web page and the modules, etc. will be explained referring to the drawings.

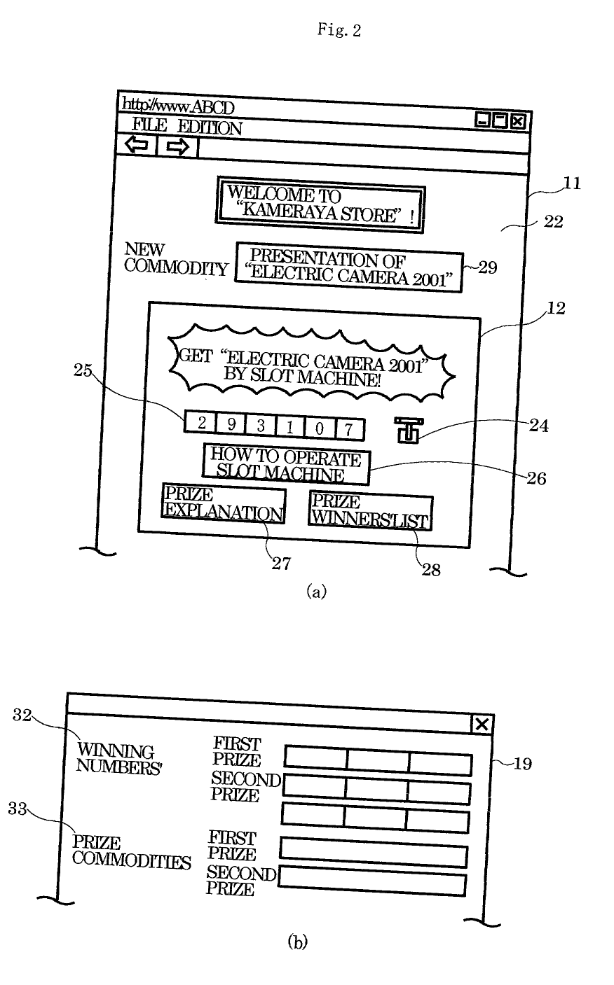

FIG. 2(a) shows a specific example of the commodity advertising web page 11 and the game module 12, and FIG. 2(b) shows an example of an operation display image of the game prize winning condition customizing module 19.

A commodity advertisement 22 is displayed on the commodity advertising web page 11 as shown in FIG. 2(a), where a commodity advertisement of a new product named “Electric Camera 2001” is displayed, for example. The game module 12 is posted on the web page for customers sparing a certain period of time in enjoying looking around the web page. The commodity advertising web page 11 may present commodities which are sold at specialty shops and at department stores, or may present any other commodities such as traffic ticket reservation service or hotel reservation service. The presented commodities may or may not be charged money, if the commodities are to be presented to many customers using the home page.

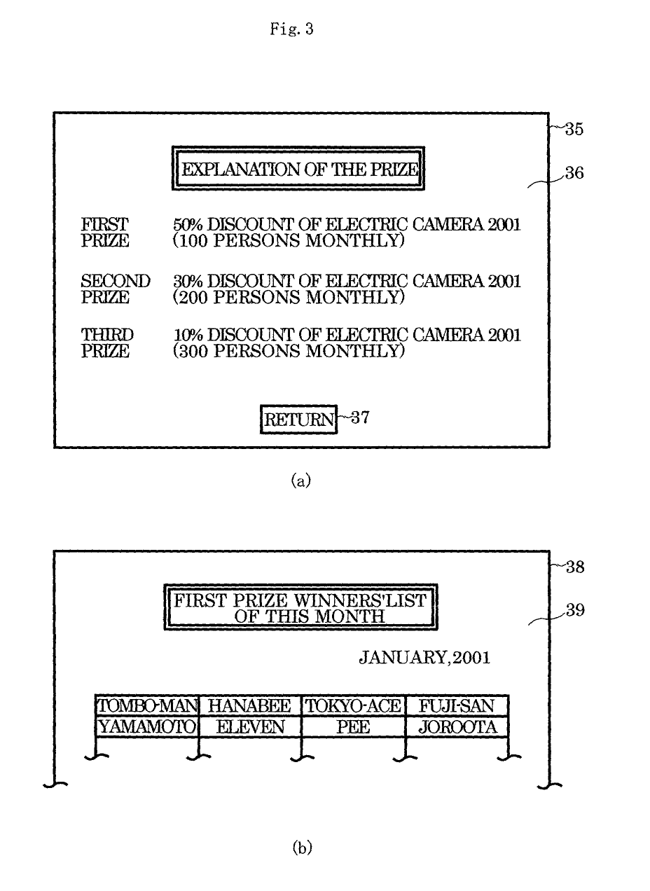

A slot machine (or fruit machine) 23 is displayed as the game module 12 in this example. When a lever 24 is clicked, the number displayed on the slot machine 23 changes randomly for a certain time period. Then, the number displayed last is compared with a certain winning number, and the prize winners of the game are decided. Any other games can be set up such as poker game or roulette. An operation manual display button 26 is disposed to explain the method for playing the game. When the button is clicked, a page explaining the method for playing the game (not shown here) is displayed. The game module 12 also has a prize explanation button 27 and a prize winners' list display button 28. When the prize explanation button 27 is clicked, explanation of the prizes is displayed, which will be described later referring to FIG. 3(a). When the prize winners' list display button 28 is clicked, a list or lists of the prize winners of the game executed so far is displayed, which will be described later referring to FIG. 3(b).

The game module 12 can be used by being posted on the commodity advertising web page in a similar way as a banner advertisement. The modules for controlling the game module 12—such as the prize winner display module 13, the prize winning process module 14, the prize winners' list revising module 15, the prize winners' list 16 and the game prize winning condition customizing module 19 shown in FIG. 1(b)—are installed in certain memory regions of the web server and are operated.

The game prize winning condition customizing module 19 is disposed for the manager of the commodity advertising web server to set freely the conditions of winning the prizes of the game module 12. For example, the winning numbers and their prize commodity can be easily changed by inputting the winning numbers 32 and the winning prize commodity 33. The probability of winning the prizes can be changed, and the number of the prizes can be changed. With the game prize winning condition customizing module 19, the provider of the game module 12 can run the business only by charging process after the game module 12 is posted on the commodity advertising web page and a program for controlling the game module is installed in the web server. Thus, the managing load of the game module provider is reduced, while the web server manager can advantageously customize the game module flexibly.

FIG. 3(a) shows a web page displayed when the prize explanation button 27 of the game module 12 shown in FIG. 2(a) is clicked. This web page 35 includes an explanation 36 which explains the game prizes. The customer can know the advantages he or she can get when he or she uses the game module 12. When a “RETURN” button 37 is clicked, the game module 12 (FIG. 2) is displayed again. The web page 38 shown in FIG. 3(b) is a page displayed when the prize winners' list display button 28 is clicked. This page includes a table 39 listing up the names of the prize winners. This web page 38 is obtained by the prize winner display module 13, editing the prize winners' list 16 shown in FIG. 1. The prize winners' list 16 comprises listed up data of the prize winners' names displayed in the table 39 shown in FIG. 3(b). The prize winner display module 13 has a program for editing the web page 38.

Thus, the prize winners' list is displayed, and the customers who have won the prizes can find their own names on the web page 38 when they look at the web page again by operating the game module 12, which would enhance their liability on the game and would give incentives to look at the commodity advertising home page again.

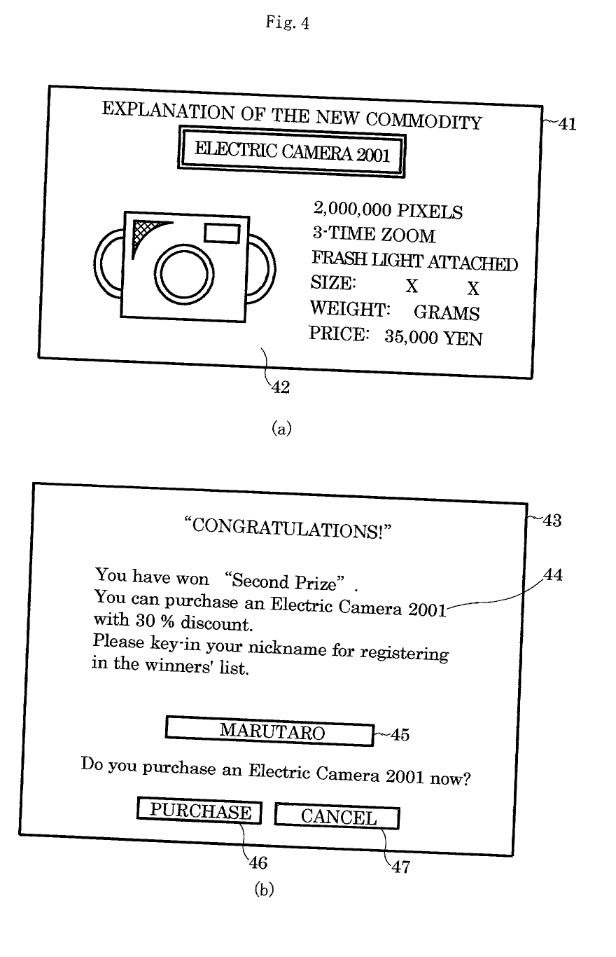

FIG. 4(a) shows an example of a web page for presentation of a new commodity, and FIG. 4(b) shows a web page displayed for prize winning process after a customer has won a prize as a result of the game module operation.

The web page 41 shown in FIG. 4(a) is displayed when the new commodity presentation button 29 shown in FIG. 2 is clicked. Thus, detail information about various commodities and services can be transmitted to the customers.

FIG. 4(b) shows an example of a web page 43 displayed, when the game module 12 shown in FIG. 2(a) was operated and a second prize was won. The web page includes an article 44 which shows privileges the customer can obtain by winning the prize. Then, filling of a nickname in a text box for registering in the prize winners' list is urged. A nickname as well as the formal name can be used, which would prevent hesitation of inputting the name. Thus, the name is displayed on the prize winners' list and the customer can confirm his or her own winning of the prize. The button 46 on the web page 43 is a button to decide whether the customer purchases the commodity using the privilege given to the customer as a prize winner. Commodity purchasing process starts when the button 46 is clicked, and the process is canceled when the button 47 is clicked. If the customer would not purchase the commodity except when the customer has won the first prize, the customer would click the cancel button 47 at this time. The prize winning process module 14 shown in FIG. 1 generates a web page as shown in FIG. 4(b), for example, to inform the customer of the prize winning result.

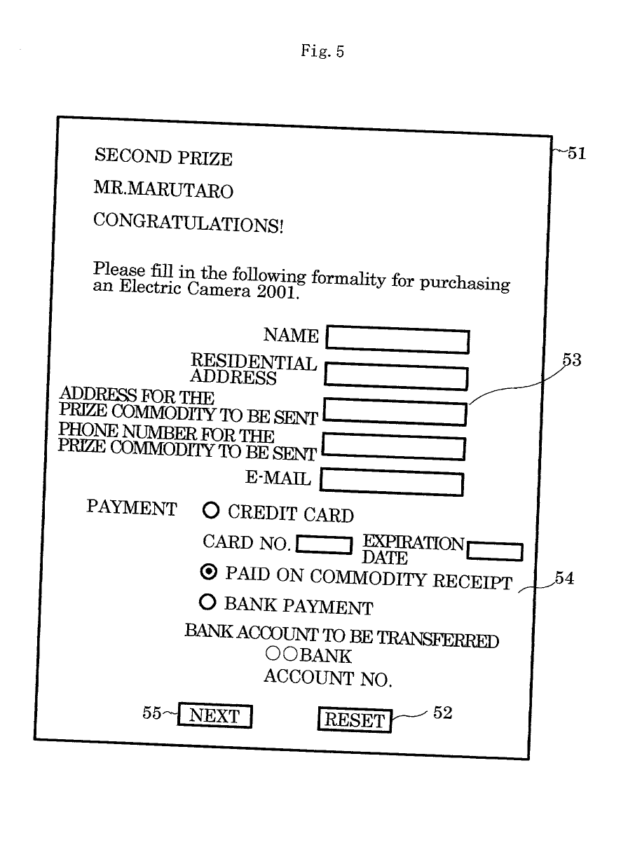

FIG. 5 is an explanatory diagram of a web page which the prize winning process module 14 will display next.

This web page 51 has a purchase process information input region 53 and a money paying information input region 54 for purchasing an Electric Camera 2001 with a privilege. In the purchase process information input region 53, the name, the address for the prize to be sent to, the telephone number and the e-mail address are inputted. In the money paying information input region 54, credit card number is inputted, for example. When the “NEXT” button 55 displayed on the web page 51 is clicked, a page for confirming the inputted information is displayed. When the “RESET” button 52 is clicked all the inputted information is cleared.

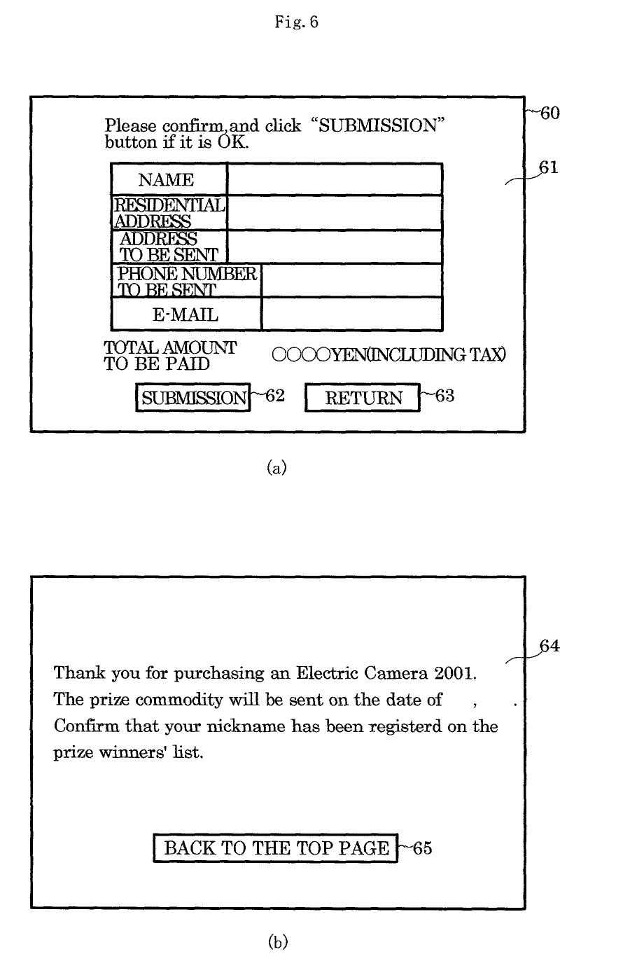

FIG. 6 is a explanatory diagram of the page for confirmation of the inputted information.

The information for commodity purchasing inputted using the page shown in FIG. 5 is edited and displayed on a web page 60 as shown in FIG. 6(a). When the submission button 62 is clicked after confirming the content, the inputted content is submitted to the web server. When the “RETURN” button 63 is clicked, the page shown in FIG. 5 is displayed again. The web page 64 shown in FIG. 6(b) displays specific procedure guidance such as the prize sending procedure. This is the web page displayed after the confirmation button 62 is clicked. After the guidance display is finished, the display is returned to the top page by clicking the button 65. The top page is the commodity advertising web page shown in FIG. 2(a). If the prize winners' list display button 28 is clicked after returning to the top page, in order to confirm that the customer is included in the prize winners, the web page 38 described above referring to FIG. 3(b) is displayed. The name may include the customer's nickname as explained above referring to FIG. 4(b).

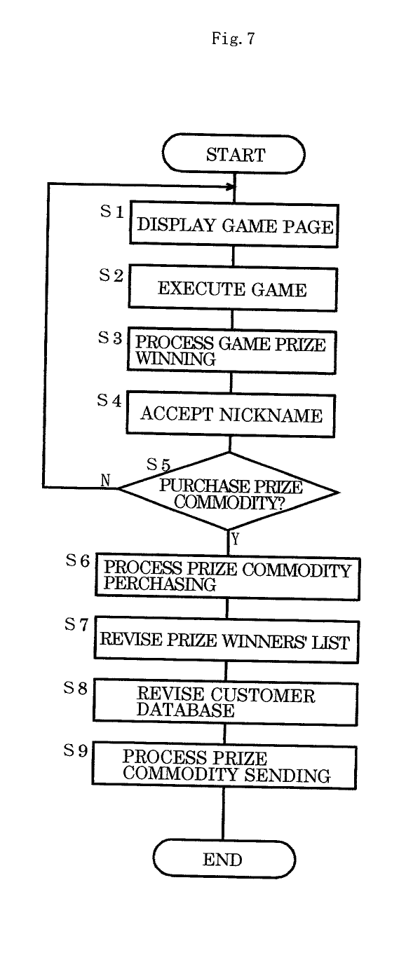

FIG. 7 is a flow chart showing specific sequential procedure of the modules for displaying and executing the web pages sequentially as described above.

First, at Step S1, a page including the game module 12 shown in FIG. 2(a) is displayed. Next, when a game is started at Step S2, game control process is executed such as changing the characters in the slot machine. When the game is over, the prize winning process is executed. The prize winning process module 14 displays the web pages shown in FIGS. 4 and 5, and the prize winning process is executed. Then, the customer's nickname is received at Step S4, and the customer is asked if he or she purchases the prize commodity or not.

If the customer replies not to purchase the commodity with the privilege, the game can be started again by returning back to Step S1. If the customer determines to purchase the commodity with the privilege, purchasing procedure with the privilege is executed at Step S6. This procedure is a series of processes using the web pages described above referring to the drawings including FIGS. 5 and 6. Then, the prize winners' list revising module 15 shown in FIG. 1 revises the prize winners' list 16. The list can be confirmed by the customer if required. The customer information registering module 17 shown in FIG. 1 registers the customer's information obtained through the purchasing procedure in the customer database 18. Thus, services, such as sending mails presenting new commodities, can be supplied to the customer. That is, the customers' information can be collected by having the customers plays the game, which would help sales promotion.

Then, sending process of the commodity with the privilege is executed at Step S9 in FIG. 7. This process may include automatic submission of or getting ready for a sending instruction slip, and informing the delivery service provider. This process is preferably executed automatically by the computer.

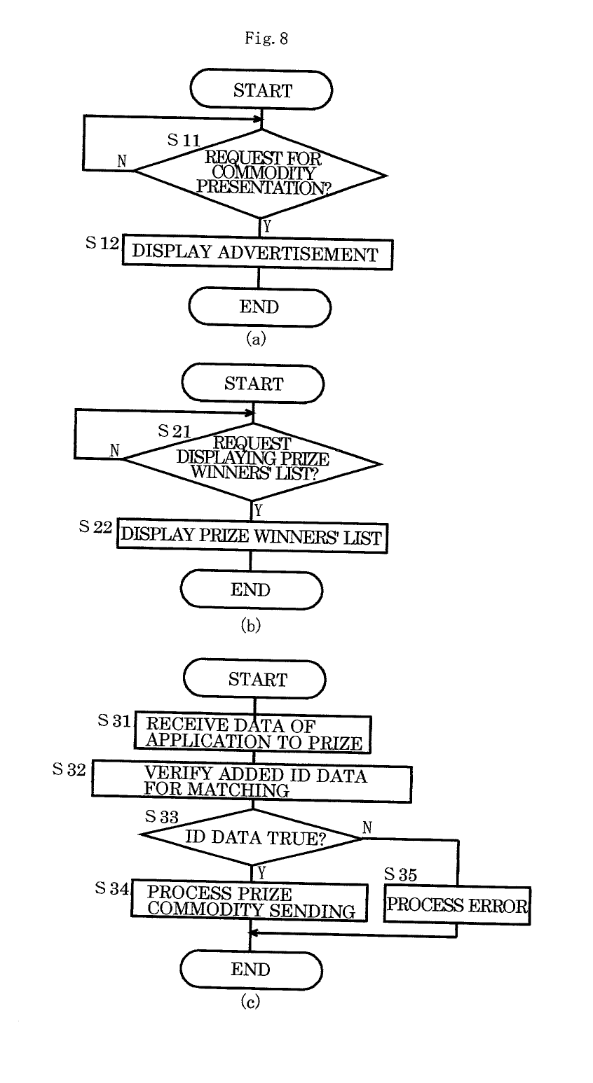

FIG. 8 shows specific operation of each module. FIG. 8(a) is an operational flow chart in a case when the prize explanation button 27 is clicked, FIG. 8(b) is an operational flow chart of displaying the prize winners' list. FIG. 8(c) is an operational flow chart of deciding truth or false with the prize winning process module.

First, if the button 27 (FIG. 2(a)) is clicked at Step S11, the advertisement shown in FIG. 3(a), for example, is displayed at Step S12. If the button 28 shown in FIG. 2(b) or the button 52 shown in FIG. 5 is clicked, Steps S21 and S22 are executed, and the prize winners' list shown in FIG. 3(b) is displayed.

The game described above is executed through looking at the web page for commodity advertisement at the web site of the commodity advertising web server 2-1 on the customer's terminal 3-1 shown in FIG. 1. At that time, the purchasing procedure with the prize winner's privilege shown in FIG. 5 is processed using the web page 51 shown in FIG. 5 which has been down-loaded in the customer's terminal 3-1. Therefore, it might be possible that a person who is not a prize winner and is pretending to be a prize winner could send information for applying for the same privilege to the commodity advertising web server 2-1 using the same terminal 3-1 which was used by a prize winner. Therefore, the prize winning process module 14 has a “true or false” decision function for deciding whether the input is from a genuine prize winner or not.

Referring to FIG. 8(c), when a prize winner's application data shown in FIG. 5, for example, is received, the prize winning process module 14 shown in FIG. 1 decides whether the attached identification data for reference is true or false. The identification data may be stored in the cookie of the customer's terminal 3-1 automatically, when the game is over, for example. The identification data may be the time and the date when the prize winning was confirmed, for example. The data is stored in a memory region of the commodity advertising web server 2-1 at that time. When a prize winning application is received by the commodity advertising web server 2-1, the identification data is checked at Step S33 to be decided whether the identification data is true or false. If the application is genuine, the identification data matches the reference data, the prize commodity sending process is performed at Step S34. When the prize commodity sending process is started, the cookie in the customer's terminal 3 is deleted automatically. Therefore, if the web page 51 shown in FIG. 5 is displayed again, and if prize application data is sent to the web server 2-1, the identification data cannot be sent out. Thus, repeated prize application based on the same prize winning is prevented.

If there are a plurality of commodity advertising web pages, the game module described above can be posted on each one of those pages. The provider of the game modules may charge the fee depending on the number of the posted game modules. While the game modules are operating, they send specified information to the managing server 4. The specified information preferably includes the information for identifying the game modules. The game module operation state informing module 20 has such a function. The game module operation state informing module 20 shown in FIG. 1 sends the game operation state information of the game modules to the game module managing system 5 of the managing server 4. The information collecting means 7 collects this information. Then, the number of the game modules being used on the commodity advertising web server 2-1 is calculated by counting the times operation state information is periodically received.

Suppose the informing module 20 sends the operation state information to the managing server 4 every thirty (30) minutes, for example. If the same web server sends the information five (5) times in thirty minutes, it means that five game modules are operating normally. In the license database 6, the numbers of the game modules licensed to be posted on each of the web servers. The money charging means 8 calculates usage fee corresponding to the number of the game modules licensed to each web server, based on the information collected by the information collecting means 7 and the content of the license database 6. Thus, royalty fee calculation for the game module licensing and money collecting process can be automated.

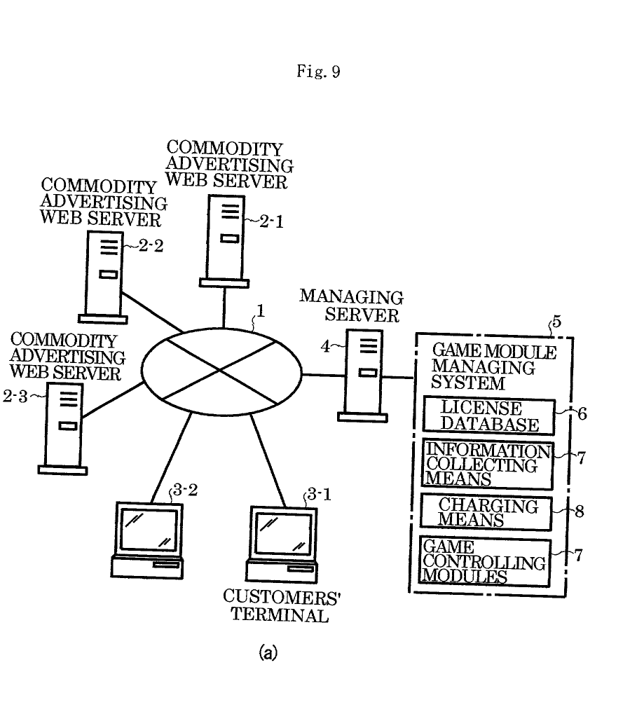

FIG. 9 is a block diagram showing a modified embodiment of a system adapted to be added to a web site according to the present invention.

In this system, similarly as in other systems described above, arbitrary number of commodity advertising web servers 2-1 through 2-3 are connected to the network 1, and the commodity advertising web pages are looked at on the customers' terminals 3-1 and 3-2. In addition, the game modules are operated using the managing server 4 connected to the network 1. The managing server 4 has a game managing system 5. The game managing system 5 shown in this figure has a license database 6, information collecting means 7, money charging means 8 and a set of game control modules 9.

The license database 6 is a database recording the state when the system for using the game is licensed to the commodity advertising web servers 2-1 through 2-3. The information collecting means 7 collects and records the operation state when information collecting operation for giving the privilege to the prize winners was performed. The money charging means 8 performs money charging process charged on the managers of the commodity advertising web servers 2-1 through 2-3 for using the game module. The game control modules 9 include various program modules for driving the game modules.

In the embodiment shown in FIG. 1, a game module is included in a commodity advertising web page displayed by a commodity advertising web server. However, it would be more convenient if the processes of calculation of the game module usage fee and of licensing the usage of the game modules are performed at a site where the game modules are collectively controlled. In the embodiment shown here, the managing server 4 has the game control modules 9. The game modules are controlled by a combination of various program modules. A part or all of the program modules may be disposed at the managing server 4.

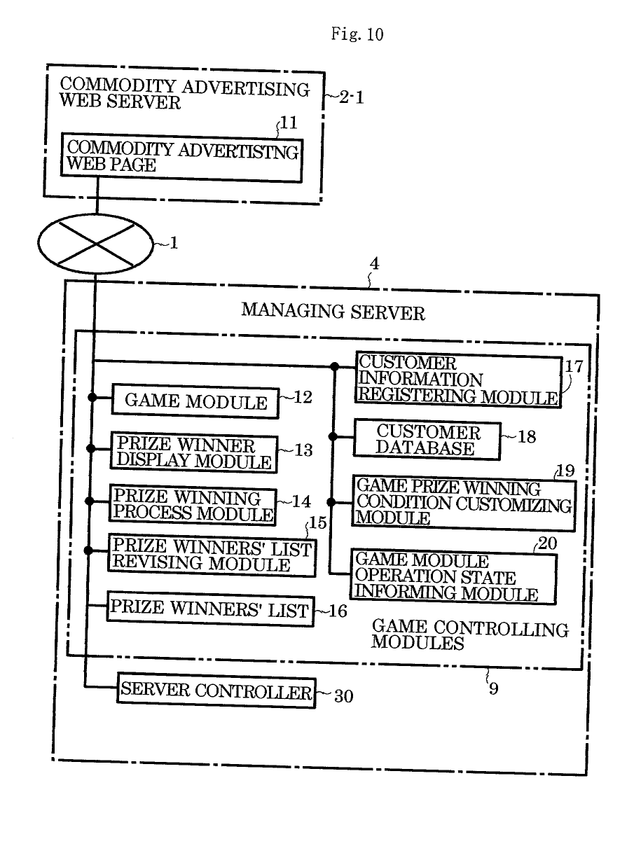

FIG. 10 is a block diagram showing the managing server 4 which has all the game controlling modules 9 required for the game.

The game control modules 9 are shown in detail and the other part known in the art is shown collectively as a server controller 30 in the managing server 4. The game control modules 9 include a game module 12, a prize winner display module 13, a prize winning process module 14, a prize winners' list revising module 15, a prize winners' list 16, a customer information registering module 17, a customer database 18, a game prize winning condition customizing module 19 and a game module operation state informing module 20. Those modules are stored in a memory device in the managing server 4.

For example, the commodity advertising web page 11 provided by the commodity advertising web server 2-1 is looked at on the customers' terminal 3-1. When a link button such as a banner on the commodity advertising web page 11 displayed on the customers' terminal 3-1 is clicked, a game module 12 is started. Then the game display image provided by the managing server 4 is looked at on the customers' terminal 3-1. Then, the game process described above referring to FIG. 1 is executed under control of the managing server 4. When the game is over, the commodity advertising web page 11 provided by the commodity advertising web server 2-1 is displayed again.

In the construction described above, the commodity advertising web server 2-1 posts a link button such as a banner on the commodity advertising web page 11, and does not have to perform other operation such as starting and controlling of the game modules. The managing server 4 executes the game processing responding to the requests from any of the commodity advertising web servers. Thus, the managing server 4 can advantageously and surely execute billing process of the game usage to the managers of the commodity advertising web servers 2-1 through 2-3 collectively. Besides, if all of the game processes are performed in the managing server 4, the load on the managing sever 4 might be too heavy.

Then, the load may be distributed by performing some of the controls of the games in the commodity advertising web servers and by performing the rest of the controls in the managing server. For example, the process may be performed by the commodity advertising web server from the start of the game to the decision of the prize winning, and then, if the prize is won and certain customer managing process is required, the required information may be transferred from the commodity advertising web server to the managing server. Then, the managing server may execute the prize winning process. Such a cooperative procedure may result in reduced loads on the commodity advertising web server and on the managing sever, while the game fee can be surely billed based on the number of the prize winnings by collectively managing the process after the prize winning.

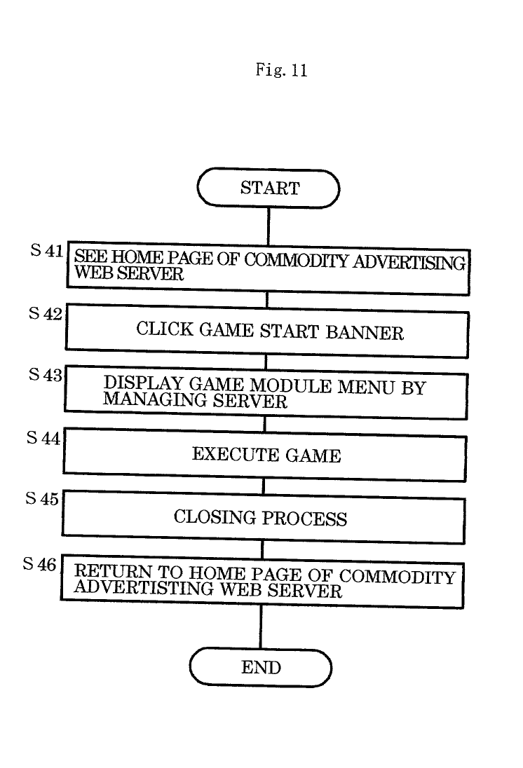

FIG. 11 is an operational flow chart of the system shown in FIG. 9.

Now an example of operation of the system shown in FIG. 9 is explained referring to this flow chart.

First, at Step S41, the home page of the commodity advertising web server is looked at on the customer's terminal. At Step S42, the game start banner disposed on the home page is clicked. At Step S43, the game module 12 of the managing server is started, and the game module menu is displayed on the customer's terminal. Then, the customer operates the menu and the game is started. After the game is executed (Step S44), closing process is performed including the prize winning process (Step S45). When a prize has not been won, the game may be repeated again. When a prize has been won, the prize winning process described above is executed. At that time, the prize winner display module 13, the prize winning process module 14, the prize winners' list revising module 15 and the prize winners' list 16 may be executed. After the closing process is finished, the control is returned to the commodity advertising web page 11 (Step S46).

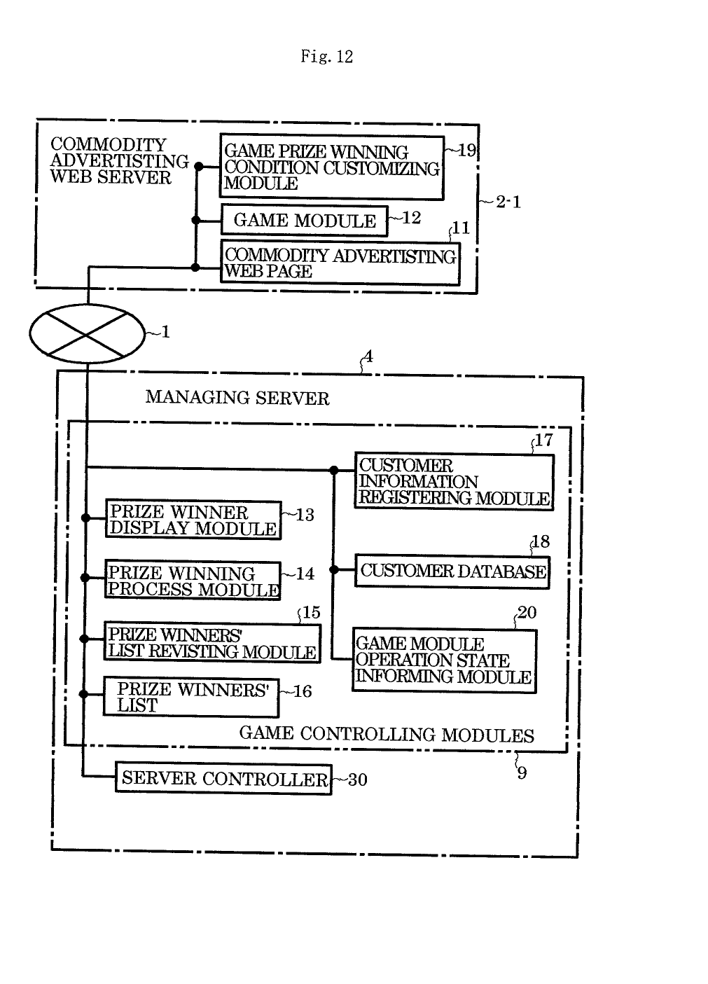

FIG. 12 is a block diagram showing a managing server where the game module 12 and the game prize winning condition customizing module 19 are disposed in the commodity advertising web server and the other game control modules 9 are disposed in the managing server 4.

Thus, the load is distributed, although explanation is omitted since the function of each of the blocks is the same as those shown in FIG. 9.

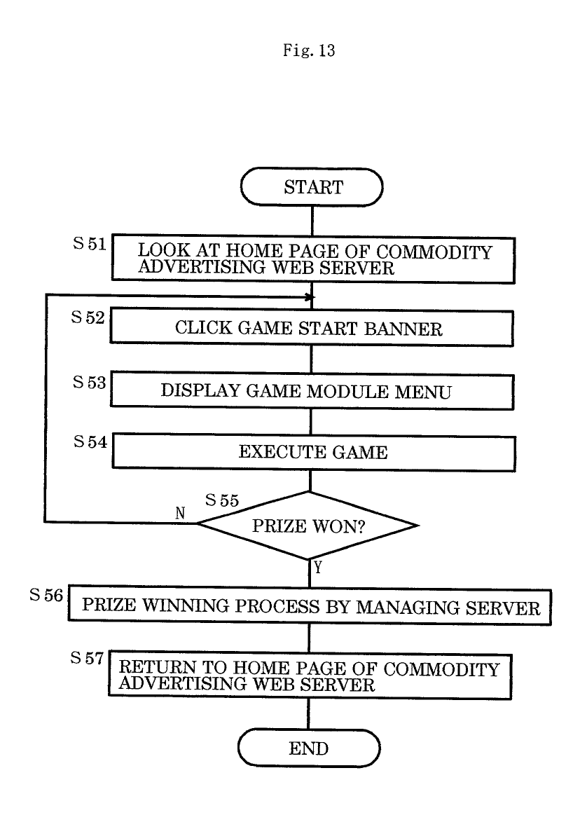

FIG. 13 is an operational flow chart of the system shown in FIG. 12.

First, at Step S51, the home page of the commodity advertising web server is looked at on the customer's terminal. At Step S52, the banner for game starting is clicked on the home page. At Step S53, the game module 12 of the commodity advertising web server 2-1 is started and the game module menu is displayed on the customer's terminal. The customer operates the menu and starts the game. Then, the game is executed (Step S54), and closing process including the prize winning process is performed in the end. When a prize has not been won, the control returns from Step S55 to Step S52, then, the game may be repeated again. When a prize has been won, the control proceeds from Step S55 to Step S56, and the prize winning process is started at the managing server 4. At that time, the prize winner display module 13, the prize winning process module 14, the prize winners' list revising module 15 and the prize winners' list 16 operate. When the prize winning process is finished, the control returns to the home page of the commodity advertising web server again (Step S57).

The functional blocks shown in FIG. 1 may be configured in separate program modules or in a single integrated program module. In addition, all or part of the functional blocks can be configured in one or more hardware devices with logic circuits. The program modules can be operated in combination with one or more existing application program, or can be operated as independent programs. The computer programs for realizing the present invention may be stored in a computer readable recording medium such as a CD-ROM, and may be installed in a computer and used. Alternatively, the programs may be downloaded in a computer memory through the network.

What is claimed is:

1. A system adapted to be added to a web site, the system comprising:
a game module adapted to be added to a web site for advertising a commodity, the web site being adapted to be looked at through a network, the game module executing at least one game;
a prize winning process module for collecting information for giving pre-determined privilege to prize winners of the game executed by the game module;
a prize winner display module for displaying a prize winners' list listing up prize winners who won the prize; and
a prize winners' list revising module for adding new prize winners to the prize winners' list, the new prize winners being processed by the prize winning process module.

2. The system adapted to be added to a web site according to claim 1, the system further comprising:
a customer information registering module for registering customer information in a customer information database, the customer information being collected by the prize winning process module.

3. The system adapted to be added to a web site according to claim 1, the system further comprising:
a prize winner condition customizing module for arbitrarily setting conditions for prize winners of the game which is executed by the game module.

4. A game module adding service system comprising:
at each of a plurality of web sites:
a game module adapted to be added at a web page for commodity advertisement to be looked at through a network, the game module executing at least one game;
a prize winning process module for collecting information for giving pre-determined privilege to prize winners of the game executed by the game module;
a prize winner display module for displaying a prize winners' list listing up prize winners who won the prize;
a prize winners' list revising module for adding new prize winners to the prize winners' list, the new prize winners being processed by the prize winning process module; and
an operation state informing module for sending information of operation state of the prize winning process module to a managing server; and
at the managing server connected to the web sites via the network:
information collecting means for collecting information received from the operation state informing modules of the plurality of web sites; and
money charging means for charging fee for using the game module by analyzing the information collected by the information collecting means.

5. A game module adding service system comprising:
at a managing server:
a game module for executing at least one game;
a prize winning process module for collecting information for giving pre-determined privilege to prize winners of the game executed by the game module;
a prize winner display module for displaying a prize winners' list listing up prize winners who won the prize;
a prize winners' list revising module for adding new prize winners to the prize winners' list, the new prize winners being processed by the prize winning process module;
information collecting means for collecting information of operation state of the prize winning process module; and
money charging means for charging fee for using the game module by analyzing the information collected by the information collecting means; and
at a web site connected to the managing server via a network:
means for linking the game module to a commodity advertising web page adapted to be looked at via the network.

6. A game module adding service system comprising game controlling means for controlling at least one game, the game controlling means including:
a game module for executing the game;
a prize winning process module for collecting information for giving pre-determined privilege to prize winners of the game executed by the game module;
a prize winner display module for displaying a prize winners' list listing up prize winners who won the prize;
a prize winners' list revising module for adding new prize winners to the prize winners' list, the new prize winners being processed by the prize winning process module;
information collecting means for collecting information of operation state of the prize winning process module; and
money charging means for charging fee for using the game module by analyzing the information collected by the information collecting means;
wherein:
the game module is disposed at a web site, and means for starting the game module is disposed on a commodity advertising web page adapted to be looked at via network; and
the prize winning process module, the prize winner display module, the prize winners' list revising module, the information collecting means and the money charging means are disposed at a managing server, and are started by the game module.

7. The game module adding service system according to claim 6, wherein:
procedure before the prize winning process is started is performed at the web site; and
the prize winning process is started in response to a request from the web site.
